(19) United States
(12) Patent Application Publication
(10) Pub. No.: US 2016/0250096 A1
(43) Pub. Date: Sep. 1, 2016

(54) TACTILE SENSORY STIMULATOR

(71) Applicants: Gail Barbara REHMERT, HAMPTON, VA (US); COLBY DEE REHMERT, HAMPTON, VA (US)

(72) Inventors: Gail Barbara REHMERT, HAMPTON, VA (US); COLBY DEE REHMERT, HAMPTON, VA (US)

(21) Appl. No.: 14/634,750

(22) Filed: Feb. 28, 2015

(51) Int. Cl. A61H 7/00

(52) U.S. Cl. CPC A61H 7/004

(57) ABSTRACT

Your applicants, Gail B. Rehmert (formerly Dreybus) and Colby D. Rehmert desire to be granted a Utility Patent for the hereinafter described improvements and enhancements to her former U.S. Pat. No. 4,312,333, a Tactile Stimulating Mechanism, granted Jan. 26, 1982. Goal of device is to relax, soothe, and calm the body and reduce stress. This modified enhanced application, renamed Tactile Sensory Stimulator, is an improvement allowing the device to reduce stress, while able to adjust to a user's large or small body type while in horizontal position. This mechanism creates a relaxing and sensitive touch over user's body by three adjustable wand assemblies holding filaments changed in figure to include light plastic orbed bendable units which do not weigh over 1-2 ounces each. This configuration of filaments creates very gentle pressure as all strands move in a rotational, reversible 360 degree orbit over the user body.

### FIELD OF THE INVENTION

The invention, Tactile Sensory Stimulator, works in the field of touch massage therapy, and the art of reducing stress, tension and avoiding illness related thereto. The improvement herein is presented for use of any person who suffers from various kinds of stress or tension.

### BACKGROUND OF THE INVENTION

Your applicant's former patent, Tactile Stimulation Mechanism was used mostly to relieve applicant's asthma, a condition of her early childhood through adulthood. The affliction was greatly agitated by tension. This utility patent, if granted, is an improvement over U.S. Pat. No. 4,312,333 as in the following ways:

When turned on, the 3 channeled wands improve the relaxing sensation in that the filaments are specifically and numerically arranged and weighted so that the soft filaments do not overcurl each other while traversing the user's body, and drop off the body in a soft rolling motion, such as over the back and down the side of user, thus continuing the relaxing touch sensation to another part of the body.

The history of touch sensation as a remedy for stress, tension, and resulting infirmities is based on biological science which tells us that touch activities can ease or hurt individuals depending on the activity of nerve signals beneath the skin's surface. These signals inform the body of harm, if pressure is too hard, or of ease, as in a gentle touch, or hot or cold such as “goosebump” type reactions. That is because nerve endings beneath the epidermis report to the brain on the varying strength and intensity of the touch.

Light tactile stroking is known to be useful during natural childbirth procedures to lessen the impact of muscular contractions. Magazines often offer articles informing readers that unrelieved physical and mental anxieties and tensions may result in severe illness, and that said anxieties may be relieved through various kinds of stimulation, such as physical therapy techniques, massaging, controlled breathing, or other forms of self-help.

There are also many mechanical devices which are available for tension relief, for those who are dealing with mental or nervous strain. Most fall into the category of deep pressure or vibration machines, massaging units, or back, shoulder and neck devices which move deep body tissue underlying the surface of the skin. However, today there are also those in the medical field who recognize the benefit that gentle relief through touch often relieves tension and stress as well as deep pressure.

This invention works on the basis of biological principles which declare tactile interruption of certain pressoreceptors located in the dermal layers of the skin, pass on information to the autonomic nervous system, the result being a pleasant and gentle touching sensation, sometimes called “tickling”. Some of these devices are cited below.

### PATENTS CITED

The following patents were cited by attorney using the U.S. database of published patents and patent applications as being in the realm of “prior art” mechanisms to our herein Tactile Sensory machine. The patents are said to create soothing relaxation but are differentiated from the patent we seek by either differing utilities, form, parts, mechanizations and/or delivery methodology:

U.S. Pat. No. 6,074,353: “Device for Caressing the Body, has strips of flexible soft material hanging from a horizontal support above the body. A motion source is used to move the horizontal support over the body so that the strips can contact the body with varying degrees of tactile sensitivity . . . to caress, tickle, scratch, numb and create arousal sensations” . . . Mechanics therein described do not appear to encumber our desired patent or have the same actions, use the same utensils and create the same reaction as in “scratch, numb or create arousal”.

U.S. Pat. No. 6,679,858: “Device To Assist in Relaxation and Relief of the Stress of a Subject, placed next to a bed on which the subject lies prone . . . the sweep arm is equipped with depending fingers that make constant contact with the subjects back when the height of the support column is properly adjusted. Different types of fingers can be reversibly attached to the sweep arm (which) moves in a back and forth motion controlled by the rotating motor”. Mechanics therein described do not appear like ours nor does ours sweep “back and forth” nor present fingerlike attachments and other differences.

U.S. Pat. No. 5,725,484: “Manual Personal Massager, comprising a pair of handles to be gripped by the hand of a person. A web network grid is provided. A plurality of massaging members are carried in the web network grid to be applied to a body part of a person and moved back and forth by the movement of the pair of handles”. Mechanics therein described do not appear like ours which does not move “back and forth” nor have a “web network grid with handles”among other differences.

U.S. Pat. No. 3,799,155:“Massaging Machine, comprising a plurality of massaging elements, preferably of spherical configuration, each of which is suspended by a non-rigid line from a common supporting structure . . . of flexible strips, a plurality of beaded lines and of flexible strands”. Mechanics therein described do not appear to be as simple or easily assembled as ours, and other differences.

U.S. Pat. No. 4,041938: “Massage Apparatus, for simulating a hand massage by a masseuse including a bracket having a plurality of flexible massage fingers for contact with the torso . . . reciprocal in a horizontal and vertical direction and can oscillate as the fingers massage the torso”. Mechanics therein do not appear to be alike, and do seem to be quite cumbersome to use.

### SUMMARY OF THE INVENTION

This Tactile Sensory Stimulator is designed to improve the Tactile Stimulating Mechanism as follows:

(a) The former motor with motion gears in the base is now discarded due to unnecessary duplication of movement.

(b) Instead, the base and support structure for holding the improved utility invention is a metal fixture which attaches to a bedside table and which effectively uses the same framework as an architectural lamp base to uphold the motor housing. This architectural type support structure is an improvement over the former bendable support shaft in that it is composed of two tri jointed metal movable long arm assemblies which allow adjustments for both large and small body types, while the former bendable support arm was limited to the smaller user.

c) There also exists an alternate base, a heavy metal anchoring unit into which the arm and support unit fits, so that one can use equipment on tabletop instead of bedside attachment.

(d) The framework leads up to the motor and hood assembly housing a small (6 rpm) rotating electric motor and cord.

(e) The motor housing attaches by drive shaft to a tri-armed plate each attached to a wand.

(f) These wands are loaded with specified filament strings and rotates 360 degrees which can be reversed by switch or touch.

(g) Each wand is carefully designed to have a maximum of 7 long stringed orbed filaments, knobbed to be gently heavier at their end, and each one long string followed by similarly short stringed filament not weighted at the end, for no more than 13 units per wand, easily removed for less units if needed, as strings slide out of wand channel.

(h) Strings range in length 7-12 inches and weigh no more than 1-2 ounces.

(i) An attachable baton to maneuver the support arm mechanism is available in the event one finds that they are unable to reach back to the on/off switch when laying in a prone position.

The sensory mechanism works similarly on other body parts than one's back while transversing 360 degrees over the area to be touched. This works by delivering a soft, gentle touch or “tickle” sensation which automatically relaxes the body due to biological principles as stated.

The tactile mechanism of this patent application is designed to deliver a very light touch to the skin of the individual's back or other receptive area, giving a pleasant rolling sensation and a relaxing response to the body. The current device, which parts are hereinafter drawn, numbered, and explained in detail, causes high strung individuals to relax by way of the next effects.

The ability to feel a more gentle sensation to the skin's surface is felt due to the rotational motion of the orb-enhanced filaments, in which a very light weighted number of filament cords are passing over the back (or other preferred area) in a clockwise or counter-clockwise optional rotating direction. Filaments are specifically positioned in each wand away from the rotating axis so that all movable units roll over the area and drop off the edges of the back area (due to more orbed filament endings) and down the side of the user. The effects of the above enhances the gentle, light “tickling” motion the rolling then drop-off elements give. These filaments may be either entirely orbed or strung partly onto the filament, and are specifically uneven in length, but not more than 1-2 ounces in weight each, to guarantee the light, gentle touch assembly for the fore-mentioned three wands.

The purpose of the completed patent upgrade will allow for the totality of the invention to be available for adjustment over the bodies of both large and small people and produce a lighter and gentler stimulation to the epidermal skin layer. That it can be usable by most body sizes and types while satisfactorily reducing tension is enhanced not only for nervous or high strung adults, but also is calming for overly energetic children as well. These changes will produce a smoother and lighter touch sensation to the body which comes about from the modification of the wand and filaments and its regulated motion, weight, size and number, and the add-on directional rod attached to the architectural base in order to allow for the user to adjust the mechanism to a different position over the body while lying in a prone posture.

### BRIEF DESCRIPTION OF THE DRAWINGS

The above and various and other objectives and advantages will be apparent from the following description and claim and from the accompanying drawings, wherein in said drawings:

FIG. 1: Is a perspective view in cross-section of the complete invention showing the architectural type support base with large spring-balanced arms, electric wiring therein, on/off switch, base assembly, motor with hood, control units, drive system shaft, head, and bar which leads to and attaches triple wands and filament orbs.

FIG. 2: Indicates the attachment equipment to latch the invention to a bedside table.

FIG. 3: Shows the weighted base unit which would hold the invention in place on a tabletop, instead of attachment to a bedside table.

FIG. 4: Are two types of stringed filament orbs, long and short which extend one after the other across the wand. FIG. 4 indicates the short orbed filament which contains fewer orbs at the bottom and is not knobed at all, thereby giving a lighter touch sensation.

FIG. 4A: Is the longer of the filaments containing more orbs, several of which are joined together at the end for additional weight, thereby giving the user two variable degrees of light touch sensation.

FIG. 5: Indicates the hood assembly with motor, wire to support column, connecting pin and receptacle holding a 3 pronged plate to which the 3 wand crossbars are attached with indicated stringed orbs.

FIG. 6: Shows the underside of the hood assembly and 3 arm plate with the channeled wand attached. Circles drawn over channel indicate where filamented orbs are attached.

FIG. 7a, 7b, 7c: Underside, side view, and topside of plate which attaches the 3 wand assemblies to the motor housing connection 39 of FIG. 7b.

FIGS. 8 and 9: Indicates the topside and bottom (channel) side of each of the three wand assemblies as well as showing the position of the screw holes 37, attachable to plates 30a and b of FIGS. 7a and 7c at screwholes 38 in each unit.

FIGS. 8a and 9b: Shows the end views of FIGS. 8 and 9 indicating a circular pattern to each view, with channel located on the underside of FIG. 8, and channel exposed on the upside of 9b.

### DETAILED SPECIFICATIONS OF THE INVENTION

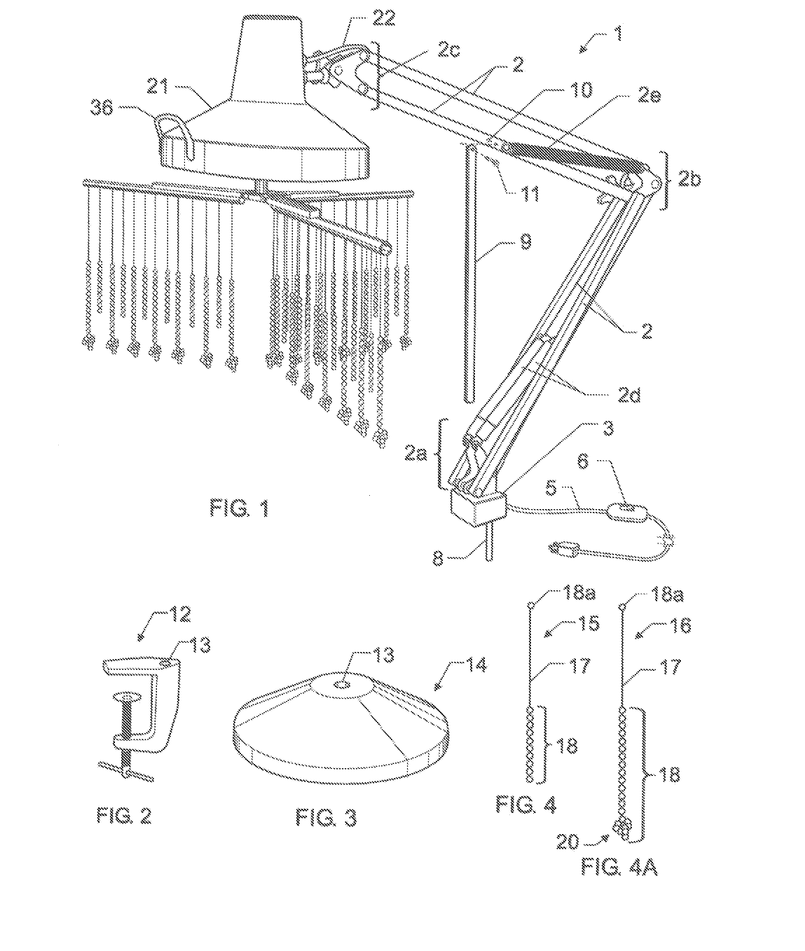

Referring in more detail to the drawings and particularly FIG. 1 pg. 1, the invention starts with a drawing of the complete structure 1. There is shown at base 3 a metal anchor pin 8 for alignment with receptor 13 of FIG. 2, table clamp 12, which securely attaches to a bedside table edge where the user may begin to set up his/her tactile massage. An extra metal base 14 is also available shown in FIG. 3, which has sufficient structure and strength to support the mechanism when receptacles 8 and 13 are joined and stabilize the invention for use. Supporting the invention in FIG. 1, are elements of an architectural lamp base composed of metal armature support shaft 2 comprising three joints 2a 2b, 2c that work together with tension springs 2d, 2e for multiple positioning as needed by the user. There exists an adjustment handle 36 located on the outside of hood 21 which can help user place the invention over the desired area for his/her gentle massage.

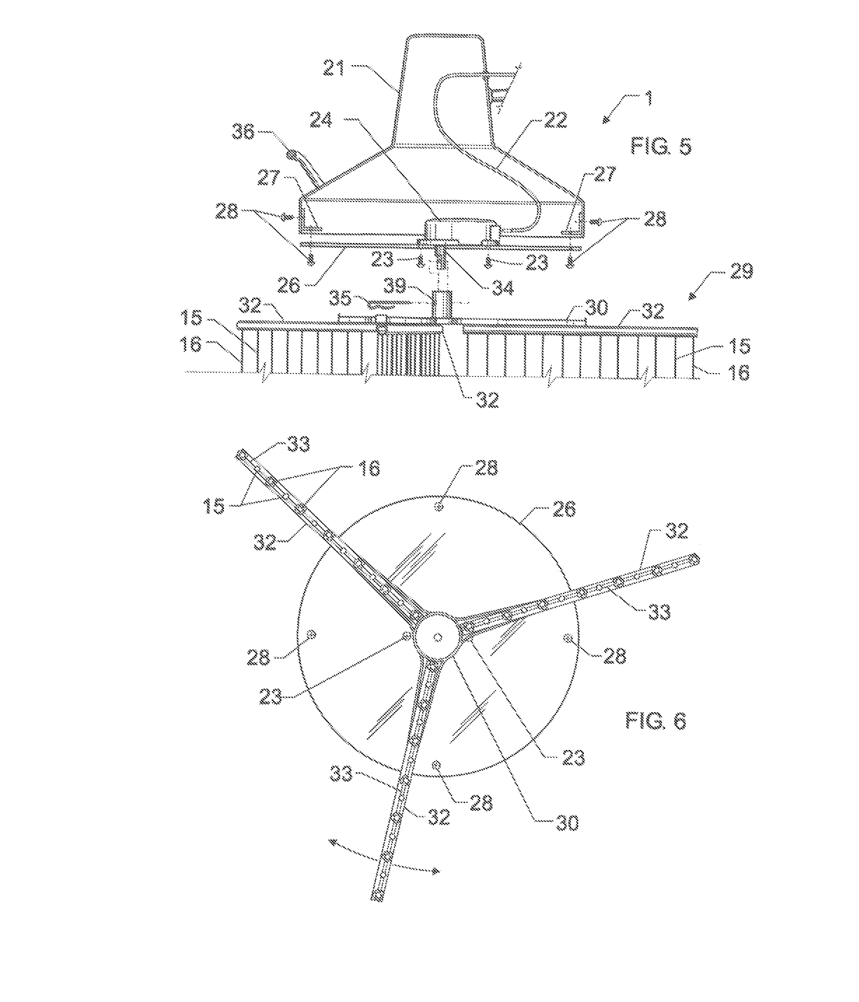

The support structure attaches to the motor housing unit 21 by the hood attachment at joint 2c, as motor cord 22 joins at the top of the moveable jointed arms. The hood housing confines the 6 rpm motor 24, FIG. 5, pg. 2 to the bottom inside motor holding base 26 with attachment screws 23 firmly secured to motor holding base, linked by screws 28 into parts 27, a 90 degree L shaped plastic mounting, all of which close the motor hood assembly leaving the upper portion of the driveshaft to attach to the working elements of the wand assembly. As an addition to add user maneuverability while in a prone position, FIG. 1 shows an alternate baton 9 available to be connected by screw 11 at hole 10, if desired for adjustability.

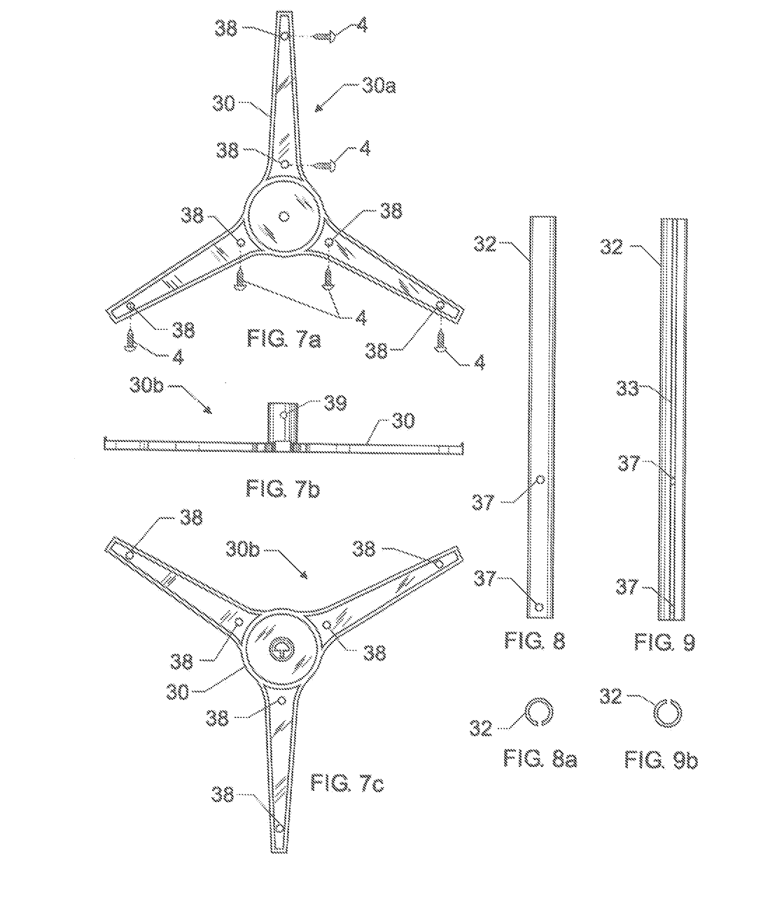

In FIG. 5 pg. 2, protruding out of the motor holding base below the motor is the top portion of driveshaft 34 which connects with lower portion of driveshaft receptacle 39 by cotter pin 35 shown connecting the lower plate and wand assembly, which is the working part of the Tactile mechanism powered by its motor assembly. The lower portion of motor drive shaft 39, 30, 32, 15, 16 can be better understood from drawings page 3 wherein FIGS. 7a and 7c show the 3 armed plate 30 of FIG. 5, its topside 30b and bottomside 30a. FIG. 7b shows a side view of the plate with driveshaft receptacle 39 on top. This plate intervenes from motor 24 to the 3 working wand assemblies of FIG. 6 which drawing FIGS. 8 and 9 depict upper and lower sides of wand 32 as it connects with plate 30 at screw holes 37 and 38 in these two drawings. Briefly, wand units 8a and 9b indicate their circular shape with channel 33 in the downside position, to receive the filaments which carry out the gentle massage.

These attachments to the motor are constructed so that the wands 32 can be easily unattached if needed to change or remove string orbed filaments 15 and 16 without having to adjust or bother the motor. Therefore hole numbers 38, page 3 in both of the above figures are where screws 4 attach plate 30 with wand tubing 32.

Each of the three wands hold up to twelve inch varying length plastic orbed filaments No. 15 and 16 as shown in FIGS. 4 and 4A. In these drawings 18a represents a top orb for the filament's channel entry, with string part 17 holding orbs 18, where each filament slides into the wand channel 33, FIG. 9, and are located below the drive shaft, FIG. 5, see #15 and #16.

The invention's string filaments with orbs attached, one string longer than the other and bundled at the end as in FIG. 4A, are so arranged and strung to give a gentle tactile sensation to the varying high and low shapes of the user's body.

FIG. 6, page 2 shows the underside of FIG. 5 which is the bottom of the 3 wands 32 attached to plate 30 as heretofore previously described by FIGS. 7a, 7b, 7c attachment with wands 32. Back of this draft shows bottom 26 of motor housing unit 21 and where they are attached at positions 28 and with motor attachment 23.

Last, the working foundation of the filaments in wands 32 channels is demonstrated by filaments 15 and 16 placed one behind the other into prehole formed places in channel 33. These filaments will rotate in a 360 degree orbit, (indicated by arrows at the bottom of FIG. 6), which motion direction can be reversed by switch or touch. The on/off switch 6 in FIG. 1 on electrical wire 5, gives user the ability to easily turn the machine on or off, as well as clockwise and counter-clockwise by gently placing one's fingers on the wand axis.

The above described embodiments of our mechanical device are preferred forms, and what we desire to secure by Letters Patent is defined in the following claims.

1. The enclosed descriptions and drawings show a Tactile Sensory Stimulating device which produces a gentle touching sensation on the body of the user thereby causing relaxation of tension and internal relief. Mechanism is comprised of:
An architectural type base and support assembly having two spring-balanced arms with 3 joints allowing ease of adjustment over the user's body size. These areas are more specifically drafted and defined by images herein attached and explained in above detailed description of the invention.
The base and support for the invention upholds a motor hood unit containing a 6 rpm 110 volt motor, with its electrical cord attaching to the support assembly through the top of the hood.
The internal motor rotates slowly in a clockwise and counter-clockwise direction at the user's discretion by clicking the on/off in-line switch or by touching one of the rotating wands.
The bottom of the motor housing unit is a closed plate material with drive shaft protruding therefrom.
It is joined through the driveshaft to a 3 arm plate connecting each of three wands of stringed filament orbs rotating in a specific pattern and which causes a light pleasant and sensitive effect to the epidermal layer of the skin, thereby relaxing the individual.

2. A Tactile Sensory Stimulator apparatus as in claim 1, whereby each of the three wands stated in claim 1 has a maximum of 7 long filament strings and 6 shorter strings, each having a length of 6-7 inches for the shorter length and 10-12 inches for the longer length, which loaded strings weigh no more than 1-2 ounces each. The end of the longer filament strings are knobed with 3-4 orbs coupled so that they will roll off of the user's back and side or other body part, so as to continue the light tactile touch which produces the relaxation needed. The strands of the wand are adjustable, replaceable, and/or removable from the wand's channel if needed in order to account for the user's sensitivity to touch and body size.

3. This device is of a type designed to be placed adjacent to a horizontal surface such as a bed or cot on which a subject lies prone. The above described device is provided and adapted for soothing, calming and relaxing an individual. The base and support structure can be used for varying body sizes, large or small. In use, an individual may place the device next to and over their body and once the motor is turned on, thereafter the strings with add-ons as described above move in a 360 degree rotation over the body, providing a relaxing massage.
